(19) United States
(12) Patent Application Publication
(10) Pub. No.: US 2014/0276281 A1
(43) Pub. Date: Sep. 18, 2014

(54) METHOD AND DEVICE FOR TREATMENT OF JOINT PAIN

(71) Applicant: Peter Nefcy, Troy, MI (US)

(72) Inventor: Peter Nefcy, Troy, MI (US)

(21) Appl. No.: 14/211,079

(22) Filed: Mar. 14, 2014

Related U.S. Application Data
(60) Provisional application No. 61/781,389, filed on Mar. 14, 2013.

(51) Int. Cl. A61H 7/00

(52) U.S. Cl. CPC A61H 7/003
USPC 601/138

(57) ABSTRACT

The present invention is for a method of treatment for joint pain and other discomfort utilizing a brush applied to the skin of the patient. The brush is used to stimulate the skin in the area of pain or discomfort, thereby conditioning the nerves in the area to be less responsive to the aforementioned pain or discomfort.

### CROSS-REFERENCE TO RELATED APPLICATIONS

This application depends from and claims priority to U.S. Provisional Application No. 61/781,389 filed Mar. 14, 2013, which is incorporated herein by reference.

### FIELD OF THE INVENTION

The invention relates to pain reduction in a patient through stimulation of the patients nervous system. More specifically, the invention is related to a method of systematically stimulating the patient's skin with a brush to condition the nervous system in such a manner that pain signals received by the brain are reduced. The invention also relates to a brush capable of providing sufficient stimulation without damaging the patient's skin.

### BACKGROUND OF THE INVENTION

Human commonly suffer pain and discomfort in their joints and other areas of their body. Numerous methods, techniques, and products have been developed to help alleviate this pain and discomfort. Currently, some of the most often used products and methods for joint pain relief and for pain in general include the use of medications which can be ingested orally, injected near the site of the pain, injected generally, or applied topically near the site of the pain. In addition to medications, surgery is often used to help rebuild, replace, or otherwise fix a painful joint.

Problems exist with these current methods and products. For example, in the case of injection, administration may require a qualified medical professional. Additionally, medications can decrease in effectiveness over time as the patient becomes accustomed to the medication, and could result in addiction to the medication. Further, constant medication requires a excessive cost to the patient in purchasing additional medications. Finally, medication can interact with other medications the patient is taking, or the patient could be allergic to certain medications, resulting in adverse conditions for the patient.

Surgery can be problematic in that it is often time consuming, expensive, and exposes the patient to risks such as infection and other dangers associated with any surgical procedure.

As such, a new pain relief method and apparatus for patients experiencing joint pain or other discomfort is desired.

### SUMMARY OF THE INVENTION

The present invention is for a method of treatment for joint pain and other discomfort utilizing a brush applied to the skin of the patient. The brush is used to stimulate the skin in the area of pain or discomfort, thereby conditioning the nerves in the area to be less responsive to the aforementioned pain or discomfort.

This method is similar to a person squeezing or rubbing a joint to help alleviate pain or discomfort; however, the method is specifically designed to maximize the efficiency of pain relief in relation to stimulation provided in the area of pain or discomfort. This method thereby helps alleviate pain or discomfort more effectively than merely rubbing or squeezing the affected area and is gentler and more sterile than a harsh rubbing, squeezing, or scratching which could be in excess of the stimulation required to alleviate the pain or discomfort and could also damage or irritate the patient's skin. Further, systematic use of the method provides for a prolonged pain relief not provided by rubbing or squeezing in times of discomfort.

The method of the present invention involves identifying a joint in a patient that is causing pain of a type treatable by the method. Once the joint is identified, the treatment method can be performed on the patient, or demonstrated and instructed so that the patient can perform the method on themselves.

The treatment method includes stimulating the skin of the patient in the entire area of the joint, including a margin area surrounding the joint. The skin is optionally stimulated by linear brushing in a proximal (toward the patient's body) and distal (away from the patient's body) manner. This brushing is conducted in a specific region of the area to be treated optionally until the skin changes color, but not so long as to break the skin or irritate, or cause other damage. Once the specific region is brushed, the brushing is optionally performed on an adjacent region within the area. This is repeated until all of the desired area has been brushed. The brushing is performed on a regular basis, for example once or twice a day, until the pain in no longer perceived by the patient. If pain reoccurs after the treatment has been stopped, then the treatment may be resumed to diminish pain. In some case is may be necessary for the patient to continue use of the treatment indefinitely.

Application to of the method can be applied to numerous areas and types of pain through the body. It is believed that benefits of the treatment can be obtained by organisms other than humans, so long as they have similarly functioning nervous systems. For example, horses and other mammals are expected to benefit from the method of the present invention.

### BRIEF DESCRIPTION OF THE DRAWINGS

FIG. 1 shows a patient suffering from joint pain to be treated by the method;

FIG. 2 shows the patient practicing the brush method;

FIG. 3 shows a flowchart for practicing the present invention;

FIG. 4 shows a brush for practicing the present invention;

FIG. 5 shows an alternate brush for practicing the present invention; and

FIG. 6 shows the alternate brush in a separated condition.

### DETAILED DESCRIPTION OF THE PREFERRED EMBODIMENTS

The present invention utilizes a brush 20 to stimulate the skin 25 of a patient in the area of a joint 30 having pain or other discomfort. A patient can be any mammal or primate with a similar nervous system to that described below, including, but not limited to a human, a horse, a dog, a cat, a monkey, etc.

In some embodiments a brush 20 for the method disclosed herein is comprised of a plastic handle 45 with groups of plastic bristles 50. Alternatively, a brush having a metal handle with plastic bristles may be used. Metal and plastic are preferred materials of manufacture in that they may be easily cleaned and sterilized using methods known to those skilled in the art. Brushes having bristles of natural fibers have not been found to be effective for this method in that they tend to scratch the skin and they are harder to sterilize thereby increasing the worry of contamination with bacteria.

The bristles or the groups of bristles 50 on the brush 20 may be relatively even in length, creating a uniform surface and length not varying more than 1 millimeter. The groups of bristles 50 optinally contain clusters of 20 to 30 individual bristles optionally arranged in a square or oval configuration. The ideal bristle length varies from 5 to 15 millimeters and should be of sufficient stiffness to resist bending or deforming while brushing the skin 25 with mild pressure. The total surface area of the bristles is optionally between 20 and 30 square centimeters. Having the groups of bristles 50 separated from each other as show in FIG. 4 has been found to be more effective that having groups of bristles tightly packed together (not shown). Other configurations may also be useful but have not been evaluated.

The above described brush 20 is ideally used for a single patient receiving the treatment. An alternate brush 55 can be used in a clinical environment where the alternate brush is used for multiple patients. The alternate brush includes a handle portion 60 and a detachable bristle portion 65 having groups of bristles 50. The handle portion 60 is removably attached to the bristle portion 65, allowing the bristle portion 65 to be used for one patient, removed, and then replaced with a new bristle portion for another patient. To attach to bristle portion 65 to the handle portion 60, posts 70 and receiving holes 75 can be utilized. It is understood and appreciated that this is not the only way to removably attach the bristle portion 65 to the handle portion 60, and an means known by those skilled in the art can be utilized, so long as attachment is secure enough to allow brushing without detachment.

In selecting the most appropriate size brush and bristle configuration, the joint to be treated or area to be treated should be taken into consideration. For example, treatment of a smaller joint such as a finger or knuckle would best be suited with a smaller brush having shorter bristles with closer groups of bristles as compared to larger a brush with longer bristles with bristles spaced further apart for treatment for an elbow or knee joint.

For a treatment method, an optionally clean and sterilized brush 20 as discussed herein is obtained or provided. This brush 20 is used to stimulate the skin 25 on a patient having joint or other pain and discomfort. To stimulate the skin 25 the brush 20 is optionally moved longitudinally up and down in a single location on the joint 30 experiencing pain or discomfort. This motion may extend 2 or 3 centimeters above and below the joint 35 using mild to firm pressure and a smooth motion. This brushing motion is optionally continued until the skin 25 starts to turn red, usually about ten stokes. Each stoke is defined as a complete up and down motion. The stokes are most effective if done at a rate of 80 to 100 stokes per minute. The brushing motion is ceased before any scratches or bleeding which would indicate excessive force and pressure occur. The brush 20 is then laterally moved over, for example by approximately 2 centimeters on a wrist joint, and brushing motion is repeated. This process of moving the brush 20 longitudinally up and down with a mild pressure until the skin starts to turn red, and laterally moving the brush over to repeat the up and down motion is continued until all the skin 25 around the joint 30, including a 2-3 cm margin, has the same mild red color. The method may be performed on moist or wet skin; however, it can be performed on dry skin, although not as effectively. The method can by performed by the person having pain or discomfort on himself, or may be performed by a third party on the person having pain or discomfort. This method can be performed on any number of joints, and is not limited to the joints discussed herein.

The brush method works with or without skin cream, oil products, or other topical solutions. However, since the brush method removes several layers of dead skin as well as other dirt and oils, it is recommended that any kind of cream, oil, or other topical solutions be applied directly after the repeated brushing motion is performed and incorporated into the method, because the skin is at that point primed for ready absorption of the products.

Cream or oil products which have been found to be effective in relieving pain and promoting healing that would be especially useful in combination with the brush method include creams having the primary ingredients of camphor, menthol, Vaseline, and barleria lupulina and oils having primary ingredients of camphor, menthol, sesame oil, and castor oil.

The above described brush application to the skin is ideally performed daily. However, it is not recommended that the procedure be used more than twice a day as it has been found that over use of the method is not effective at increasing the overall amount of pain relief and may slow down the healing process through an over stimulation and abrasion of the skin. Ideally the patient performs the method at a specified time during the day so that it will become part of his routine, for example at the end of the daily shower or bath.

This method is purely mechanical in nature, it works through stimulation of various pain fibers in the nervous system, conditioning them to respond different to pain type sensations. It presents no problems involving drug interactions with previous pain treatments. As such, it can be combined with the patient's current pain medication without worrying of adverse drug interactions.

The sensation of pain in the body is transmitted through the primary pain fibers which are called Ia afferent fibers 35 (as represented by the “x”s in FIGS. 1 and 2). The Ia afferent fibers 35 sense pain arising from a joint 30 or other site of pain or discomfort in the body. The Ia afferent fibers 35 start the process of sending pain signals to the brain which eventually make us all say “ouch”. The Ia afferent fibers 35 terminate in the spinal cord at specific levels corresponding to different sections of the body. This termination is at the start of secondary afferent fibers which send signals upwards to the brain.

In addition to the Ia afferent fibers 35, the body has C fibers 40 (as represented by the “o”s in FIGS. 1 and 3) which are involved in more broad based and less specific pain responses. The C fibers 40 terminate in the spinal cord at small intermediated nerves at the same level as the Ia afferent fibers 35 and are more involved with the reflex reactions such as the quick removal of your hand when touching a hot surface. The C fibers 40 and small intermediate nerves interact with the same start of the secondary afferent fibers as the Ia afferent fibers 35, sending signals up towards the brain.

Without being limited to one particular theory, the use of the brush 20 on the skin 25 in the area of the joint 30 or other discomfort or pain stimulates the C fibers 40 in the skin 25. This extra stimulation of the C fibers 40 interacts with the primary and secondary Ia afferent fibers 35 to modulate the pain impulses that arise in the secondary pain fibers at the level of the spinal cord and reduces the perception of pain by the higher centers of the brain. Use of the brush 20 with the method further described below on the skin 25 over a period of several weeks to months resets levels of pain at the spinal cord level. This produces a net result wherein the same pain nerve output from the joint is perceived by the brain as less intense.

This brush method has been found to be effective on patients having arthritis, tendonitis, synovitis, calcific tendonitis, carpal tunnel, and plantar fasciitis. While not yet tested, this brush method could be effective for other sources of joint pain and discomfort. This method is to be used by patients with intact skin around the affected joint. The brush method should not be used by patients with existing skin rash, skin cuts, skin infection or broken skin, and is not intended for the relief of pain related to recently fractured bones. If the patient develops a rash with this method, then the cream or oil used with the program should be discontinued and the number of treatments reduced until the rash improves. With improvement of the rash, the treatment with the brush can then be continued as usual until significant pain relief is accomplish at the specific joint.

The foregoing drawings, discussion, and description are illustrative of specific embodiments of the present invention but they are not meant to be limitations upon the practice thereof. Numerous modifications and variations of the invention will be readily apparent to those of skill in the art in view of the teaching presented herein.

### EXAMPLE 1

Patient BE, a 69 year old active college professor, complained of chronic pain at the right thumb carpal-metacarpal and metacarpal-phalangeal joints. BE's pain worsened with activities such as tennis. BE also complained of intermittent carpal tunnel syndrome which worsened with typing and computer use. BE has tried PT, medications, orthotics and other devices to relieve stress on the wrists and thumb while at work. BE reports no daily prescription medications.

Treatment using the firm brush with short, clustered bristles was demonstrated. Specifically, BE used the Ms. Pedicure 2-in-1 Foot brush, product number 31203B, herein after referred to as the ‘Ms. Pedicure Brush’.

BE was instructed to brush the skin along the back of the wrist in an up and down manner along the long axis of the arm, extending 1 inch proximal and then distal to the wrist in one spot 15 times. The he was to move the brush ½ to 1 inch towards the thumb side of the wrist and repeat the brushing up and down 15 times. He was to continue to move the brush around the wrist and brush in a similar manner until the entire wrist was brushed evenly. The he was to do the other wrist in a similar manner. After the wrists, he was to brush the painful thumb in an up and down manner along the long axis of the thumb from the wrist to the tip of the thumb for 15 times at one location. He was then to move the brush ½ inch around the thumb and brush that location up and down for 15 times. He was to continue to move the brush and treat each location with brushing in a similar manner until the entire thumb and the small portion of the hand was brushed evenly. He chose to do all of this at the end of his daily shower after rinsing off soap, and with the skin wet. He was instructed to use a small amount of heating cream on the most painful site of the thumb for 1-2 weeks only.

After 6 weeks of therapy, BE's thumb joint pain was completely relieved, and has not recurred in 6 months following termination of treatment. He has not had any symptoms of CTS since starting the treatment, despite returning to daily use of typing and computers. He reports the treatment to be more effective than any other he has tried for these symptoms.

### EXAMPLE 2

Patient BM is a 56 year old professional who complained of chronic pain in the left elbow and shoulder for the past 5 years, which worsened with activity such as bowling or tennis. He has had physical therapy, prescription and over the counter oral medications, braces, topical treatments, and steroid injections without improvement of pain. He has been diagnosed with elbow tendonitis and calcific tendonitis of the shoulder, and at work wears a brace at the elbow daily for pain.

Treatment with the firm brush with short, clustered bristles was demonstrated. Specifically, BM used the ‘Ms. Pedicure Brush’.

BM was instructed to brush the skin at the elbow in an up and down manner along the long axis of the arm in one spot for 15 to 20 times, extending 2-3 inches proximal and distal to the elbow. He then was to move approximately one inch around the elbow and repeat the brushing. He was instructed to continue moving around the elbow and brushing until the entire elbow was brushed evenly. He was further instructed to repeat the procedure in a similar fashion around the shoulder, extending 3-4 inches proximally and distally. He chose to do this after his morning shower while the skin was still wet, after rinsing off all soap. After drying off, he applied a small amount of heating cream to the sites of the most pain at the elbow and shoulder.

BM's elbow and shoulder symptoms improved significantly within 4 weeks of treatment, and resolved completely within 8 weeks. He no longer uses any oral or topical medications, and stopped wearing the brace at 3 weeks. He continued treatment for 3 more months, and has stopped for the past 6 months without recurrence of pain symptoms.

### EXAMPLE 3

Patient CLV is a 59 year old physician with chronic pain in right great toe for more than 20 years. He reports pain with each step, constant pain at rest, and inability to jog, run, ski, or play golf due to severe pain. X-rays show significant damage to first metatarsophalangeal joint. CLV has tried physical therapy, hot and cold presses, braces, injections, oral prescription and over the counter NSAIDs. None of these measures have been successful in reducing or relieving his pain. He has been advised by multiple doctors that a fusion procedure is the only possible solution.

Treatment using the firm brush with short, clustered bristles was demonstrated. Specifically, CLV used the ‘Ms. Pedicure Brush’.

CLV was instructed to brush the skin at the top of the great toe at the painful joint, extending 1-2 inches proximally into the foot and distally to the tip of the toe 15 to 20 times. The he was to move the brush ½ inch around the toe and repeat the brushing. He was instructed to continue to move the brush around the toe until the entire toe and adjacent foot area was brushed evenly. CLV chose to do this at the end of his daily shower after rinsing off soap, and with the skin wet. He did not use the heating cream.

Within 10 days of starting treatment, he reported noticeable improvement of symptoms, and complete relief of pain with walking within 20 days. He reported complete relief of chronic and acute pain within 30 days. He continued the treatment for 3 more months, without recurrence of pain. He now is active with jogging and plays golf without pain, and as a side benefit has lost 25 pounds of weight due to increased activity.

### EXAMPLE 4

Patient JB is a 45 year old physical therapist with chronic pain in the 1st carpometacarpal joint of the right hand for the past 6 months, which worsens at work due to usage. She does not want to use any prescription or over the counter medications. She has treated herself with vitamin and herbal oral treatments, and topical therapy without success. She has tried hot and cold therapies without success. The pain restricts her ability to perform daily work.

Treatment using the firm brush with short, clustered bristles was demonstrated. Specifically, JB used the ‘Ms. Pedicure Brush’.

JB was instructed to brush the skin of the thumb along the long axis from the wrist to the tip of the thumb at the palm along the thenar muscle for 15 to 20 times, and then move approximately ½ inch around the thumb in a radial direction and repeat the brushing 15 to 20 times. Brushing and then moving around the thumb continues until the back of the thumb is brushed. The entire thumb from the carpal-metacarpal joint to the tip was brushed completely, and the proximal aspect to the wrist as best as possible. She chose to brush the thumb after her morning shower while still in the shower after all soap had been rinsed off. JB was further instructed to apply a small amount of the heating cream to the thump at the site of pain.

After 2 weeks of treatment, the pain improved significantly, and was completely gone after 4 week. She continued with the therapy for 3 more months, and then stopped. The pain has not returned for the past 6 months, and she no longer had difficulty performing her job.

### EXAMPLE 5

Patient LR is a 63 year old executive who is active in sports including: golf, tennis, pilates and gym. He complained of chronic right knee pain for over 10 years. Patient LR has tried physical therapy, oral and topical medications, and injections, without much improvement. He uses compression wraps and a brace for activities, and occasional over the counter NSAIDs. Patient had endoscopic surgery with meniscal cartilage repair 10 months ago, without much relief of pain.

Treatment with the firm brush with short, clustered bristles was demonstrated. Specifically, LR used the ‘Ms. Pedicure Brush’.

LR was instructed to brush the skin along the anterior aspect of the painful knee in an up and down manner along the long axis of the leg, extending 3-4 inches above and below the knee 15 to 20 times. Then he was to move the brush 1 inch to the side of the knee and repeat the brushing. He was instructed to continue to move the brush slowly around the knee, until the entire knee had been brushed evenly. He chose to do this at the end of his daily shower, after rinsing off soap, and while the skin was still wet. After drying the skin, he applied a small amount of the heating cream to the site of the most pain. The cream was to stop after 2 months, with the brushing continued. He also chose to occasionally brush a second time on the days when he exercised. On these occasions, he used the brush on the dry skin after leaving the shower, and did not use additional heating cream.

LR reported slight improvement at 8 weeks of therapy. At 12 weeks, he reported significant improvement. At 16 weeks, the chronic pain was totally relieved, and the patient stopped taking oral medications. The patient also stopped using the compression wraps and brace for activities. At 20 weeks, the occasional sharp acute pain experienced during activities was also significantly diminished but not completely gone. LR patient reports that the therapy is the best treatment for his chronic knee pain that he has ever tried.

### EXAMPLE 6

MM is a 49 year professional complaining of chronic pain in the wrists for past 15 years, which worsens with exercise and work. The symptoms are worse on the right (dominant hand). He has had EMG tests and clinical diagnosis of carpal tunnel syndrome for more than 10 years. MM's prior treatment has included physical therapy and injections of steroids. He currently wears braces on both wrists day and night 24/7, and takes prescription medication, as well as over the counter NSAIDs oral medications. The symptoms interfere with his ability to perform work at his job, and limit his activities of daily living and sports.

Treatment with the firm brush with short, clustered bristles was demonstrated. Specifically, MM used the ‘Ms. Pedicure Brush’.

MM was instructed to brush the skin at the wrists in an up and down manner along the long axis of the arm, extending one inch proximal and one inch distal to the wrist in one spot approximately 15 times, then move approximately one inch around the wrist and repeat the brushing approximately 15 times. He was instructed to continue moving around the wrist and brushing until the entire wrist was brushed evenly. Then he was to brush the other wrist in a similar fashion. He chose to do this after his morning shower while still in the shower after rinsing off all soap and with the skin still wet. After drying off, he was instructed to apply a small amount of heating cream along the back of each wrist. This treatment was to be performed once a day for the first 2 months. After 2 months, he was instructed to stop using the heating cream and continue with the brushing of the skin.

MM reported some improvement within 4 weeks of starting the treatment. He then stopped all oral medications. At 8 weeks, the improvement was significant in both wrists, and he stopped using the braces during the day on the left, and continued with the brace on the right during the day. MM continued with the braces during sleep. The cream was stopped at 8 weeks. At 12 weeks, MM was only wearing the brace on his right wrist for 4 hours a day. He reported symptoms 100% improved on the left, and 60-80% improved on the right (depending on his activity levels). He has been on treatment for past 8 months, and has returned to normal daily activity and sports. MM is hesitant to completely stop using brace on right wrist, since he does not want severe symptoms to recur. MM also wears braces during sleep as a precaution, rather than due to pain at night.

### EXAMPLE 7

Patient PMN is a 61 year old professional diagnosed with bilateral plantar fasciitis for the past five years. The symptoms worsen after exercise. PMN has tried oral medications, physical therapy, stretching exercises, and orthotics, without much relief of pain.

Treatment with the firm brush with short, clustered bristles was demonstrated. Specifically, PMN used the ‘Ms. Pedicure Brush’.

PMN was instructed to brush the skin at the heel in an up and down manner along the long axis of the foot, extending from the posterior heel forward to the metatarsal heads 15 to 20 times in one spot. PMN was then to move the brush one inch around the posterior foot, and repeat brushing. He was to continue moving around the ankle and foot with brushing until the entire area was brushed evenly. He chose to do this at the end of his morning shower after rinsing off all soap, with the skin wet. He did not use the heating cream.

PMN's symptoms were significantly improved after 2 months of treatment, and after 3 month the pain was completely gone. PMN continued with the treatment for 6 months, and then stopped. It has been 15 months since initial treatment, and symptoms have not recurred.

### EXAMPLE 8

Patient SK is a 47 year old woman diagnosed with rheumatoid arthritis for past 18 years. Her pain is most severe in the hands and feet. She takes 3 prescription oral medications as well as multiple over the counter NSAIDs daily. She wears braces on wrists and hands constantly, and has compression wraps and topical medications on hand and feet daily. SK also wears a brace on the left 4th digit for chronic subluxation. She has been on multiple biological injection medications. She reports joint flair-up every 3-4 weeks, and spends 2-3 days of sick leave each month in bed due to severe symptoms. On physical exam, she has limited range of motion in her wrists, diffuse pain, weakness, and deformity of hands.

Treatment with the firm brush with short, clustered bristles was demonstrated. Specifically, SK used the ‘Ms. Pedicure Brush’.

SK was instructed to brush the skin at the wrist in an up and down manner along the long axis of the arm 15 to 20 times at one spot, extending one inch proximal and distal to the joint. The brush was to be moved around the wrist approximately one inch, with brushing repeated at the new spot. SK was instructed to continue the brushing until the entire wrist was brushed evenly. She then was to do the other wrist in a similar fashion. After the wrists, she was to brush the hands in a similar manner extending from the wrist to the finger tips along the long axis of the hand. At the ankles, brushing was performed in a similar manner, extending 2-3 inches above and below the ankle. After each ankle, brushing of the feet along the long axis in a similar manner was to be performed. She chose to do this after she had finished her nightly shower and the skin was dry. Heating cream was only to be applied to the back of the wrists after brushing was complete. She also uses the brush in the same manner occasionally in the morning on dry skin, but not every day.

SK stopped the heating cream after 2 weeks, reporting too much heating of the skin at night. Within 4 weeks of the brush treatment, she reported significant improvement of pain in hands and feet. She then stopped all oral medications, and stopped using the wrist braces and wraps. At 8 weeks, her strength was returning to hands and feet, and she removed the brace from her finger. SK's range of motion was near normal on physical examination. Within 12 weeks, she started to diminish the frequency of injection medication. After treatment for 7 months, SK has reported no flare-ups of joint pain or joint swelling, and has taken no personal sick leave for joint pain. The deformities of the hands have stabilized. SK has found that she has to maintain treatment daily, as lapses of more than a few days results in slowly returning symptoms, which again resolve with return to treatment.

Various modifications of the present invention, in addition to those shown and described herein, will be apparent to those skilled in the art of the above description. Such modifications are also intended to fall within the scope of the appended claims.

It is appreciated that brushes and other materials are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

I claim:

1. A process for treating pain in a subject in need thereof comprising:
providing a brush;
identifying an area of skin in an area where said subject has pain;
brushing said area of skin with said brush for a stimulation period.

2. The process of claim 1 where said area of skin is the skin covering a wrist joint of the patient, including a 1 inch margin proximal and distal to the joint.

3. The process of claim 2 wherein said step of brushing is by applying 15 up and down stokes with said brush to said area of skin.

4. The process of claim 3 wherein said step of brushing is provided once per day for a minimum of six weeks.

5. The process of claim 1 where the area of skin is the skin covering an elbow joint of said patient, including a 2-3 inch margin proximal and distal to the joint.

6. The process of claim 5 wherein said step of brushing is by applying 15-20 strokes with said brush to said area of skin.

7. The process of claim 1 where said area of skin is the skin covering a shoulder joint of the patient, including a 3-4 inch margin proximal and distal to the joint.

8. The process of claim 7 further comprising applying a heating cream to said area of skin following said step of brushing.

9. The process of claim 1 where the area of skin is the skin covering the top of the Hallux, including a 1-2 inch margin proximal into the foot.

10. The process of claim 1 where the area of skin is the skin covering a thumb joint of the patient extending from the tip of the pollex to the wrist.

11. The process of claim 1 where the area of skin is the skin covering a knee joint of the patient, including a 3-4 inch margin proximal and distal to said knee joint.

12. The process of claim 11 wherein said step of brushing is performed twice a day on a day when the patient exercises.

13. The process of claim 1 wherein the area of skin is the skin covering a heel of the patient extending from the posterior heel forward to the metatarsal heads.

14. The process of claim 1 wherein the area of skin is the skin covering a wrist and hand of the patient, extending from a position 1 inch proximal to the radius to the finger tips.

15. The process of claim 1 wherein the area of skin is the skin covering an ankle joint of the patient, including a 2-3 inch margin proximal and distal to the joint.
